(19) United States
(12) Patent Application Publication
(10) Pub. No.: US 2009/0316994 A1
(43) Pub. Date: Dec. 24, 2009

(54) METHOD AND FILTER FOR RECOVERY OF DISPARITIES IN A VIDEO STREAM

(76) Inventor: Faysal Boughorbel, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 12/442,416

(22) PCT Filed: Sep. 28, 2007
(86) PCT No.: PCT/IB07/53955

§ 371 Date: Mar. 23, 2009

(30) Foreign Application Priority Data
Oct. 2, 2006 (EP) 06301002.9

(51) Int. Cl. G06K 9/46

(52) U.S. Cl. 382/195

(57) ABSTRACT

The invention concerns a method for recovery, through a digital filtering processing, of the disparities (di,k) in the digital images (1, 2; 10, 20) of a video stream containing digitized images formed of lines of pixels, so that data on the disparities (di,k) between images are yielded by the digital filtering processing. The method includes an initial stage of determination of image sites (i, j) to be pinpointed in depth, and the filtering being a recursive filtering calculating the disparities (di,k) between said sites (i, j) of said images (1, 2; 10, 20) on the basis of weighted averaging (ωi,k) governed simultaneously (1) by the characteristics (ci,1, cj,1) of the pixels of the sites (i, j) and by the image similarities between said sites (j) and sites (j′) close to said sites. The quality of the convergence of the filtering may be enhanced by adding at each iteration (k) a small random excitation (εi,k) to the depth estimate (δi,k) deduced from the disparity (di,k).

### FIELD OF THE INVENTION

The invention relates to the recovery of image disparities, for example the recovery of relief from at least two streams of synchronized stereo images, or the recovery of motion through analysis of the images of a stream of successive images.

### BACKGROUND OF THE INVENTION

The principle of optical restitution of relief by means of stereo images is well known to persons skilled in the art. This restitution is obtained for example through the use of binocular spectacles matching the respective positions of the eyes of the viewer to those of the lenses of the two video cameras. Since the various objects or characters shown in the scene in these images are Oust as in the real world) located at different points because: i) the viewpoints of the cameras are different, and ii) within the scene, the objects or characters are at different distances from the camera or at different depths, the viewer's brain restores the impression of the relief of the scene.

But rather than a mere impression, what is concerned with here is to quantify precisely the depth of the objects or characters in the scene by recovering this depth from digitized stereo image data.

In making such a recovery, one could be dealing with pictures taken simultaneously, i.e. involving in principle no movements of things or persons in the scene between the two images other than those due to the (fixed) positional offset between the cameras and any dynamic movement of the camera system, which can be presumed as known.

However, one might also want to recover movements of objects or characters between two successive pictures of a given scene taken one after the other with a constant, well-defined time interval.

Whether the recovery be made in the temporal domain as in the latter of these two cases or in the spatial domain as in the former, the problem to be resolved remains the same, and is principally that of determining shifts of things or persons between two images which may be consecutive or simultaneous.

In simple terms, if it is wanted to recover relief in a dynamic setting, one must simultaneously take account of the shifting of the camera system, the shifts due to the movements of objects in the scene, and their relative shifts in the images due to their depth. All these shifts indiscriminately cause disparities between images, which need to be quantified exactly. Subsequent calculations then make it possible to distinguish the movements and/or the shifts from the depths, or the depths from the movements and/or the shifts.

To make the recovery of the disparities—as stated in the article by Tian and Barron “A quantitative comparison of 4 algorithms for recovering dense accurate depth”, Proceedings of the Second Canadian Conference on Computer and Robot Vision, IEEE June 2005—one is compelled to use Kalman filter based methods of calculation that are generally difficult to use in the context of a real-time application.

Kalman filters are predictive recursive statistical filters assuming that the adopted representation of the variables to be estimated, in this case the depths of the image pixels, is Markovian in nature. This hypothesis makes it possible to calculate upon each iteration the covariance of the error made in the estimate of each variable before (as a prediction) and after observation, and to deduce therefrom a gain or a weighting to be applied to subsequent observations. The filter is recursive, as it does not require the values of past observations to be retained.

These filters are used a great deal, in many fields, for real-time applications where the number of variables to be estimated is sufficiently small, or where the time available between observations is sufficiently large to allow the calculations to be made for the number of variables involved. In the context of calculating the depths of stereo images, the number of variables is broadly of the same order of magnitude as that of the pixels of an image, and the time between two observations is expressed in a few tens of milliseconds at most, reckoning the number of iterations between consecutive images of the video stream as at least ten or so. At present, it is therefore not possible even to calculate just the covariances of all the variables at each iteration of the filter, yet this operation is vital for calculation of the gains of a Kalman filter.

### SUMMARY OF THE INVENTION

The applicant, having set out to realize such applications as the instantaneous restitution of three-dimensional synthesized images on 3D lenticular monitors, the instantaneous determination of reliefs through aerial or spatial photography, etc., came up against the problem of recovering image disparities in a dynamic setting and in real time.

In this context, the applicant looked for a more direct method of calculation than the method proposing the use of Kalman filters, which is inapplicable to three-dimensional visualization applications.

With this in mind, the invention relates to a method for the recovery, through a digital filtering processing, of the disparities in the digital images of a video stream containing digitized images formed of lines of pixels, so that data on the disparities between images are yielded by the digital filtering processing, the method including an initial stage of determination of image sites to be pinpointed in depth and the filtering being a recursive filtering for calculating the disparities between the said sites of the said images on the basis of weighted averaging governed simultaneously by the characteristics of the site pixels and by the image similarities between the said sites and sites close to the said sites. Advantageously, the quality of the convergence of the filter may be improved at each iteration of the calculation of the recursive filter by adding a small random excitation to the depth estimate at each iteration.

The weightings are governed solely by the observations made in the immediate neighbourhood. Calculation of covariances is avoided.

### BRIEF DESCRIPTION OF THE DRAWINGS

The invention will be better understood in the light of the following description of the recursive filtering process or processing according to the invention for recovering the relief and movement of the images of a video stream, and of the accompanying drawing in which:

FIG. 1 illustrates the depth recovery procedure carried out through recursive filtering of two images in the course of an iteration loop, and

FIG. 2 is a functional flow chart of the recursive filter according to the invention.

### DETAILED DESCRIPTION OF THE INVENTION

Digital images of one and the same scene shot from different viewpoints are supplied by two camera systems taking simultaneous pictures (not shown in the figures)—in this case, by video cameras. As the viewpoints are different, the video images constitute a set of stereo images. To simplify matters, one will consider only two systems supplying the images 1, 2, though the processings which will be described later can also be applied to more complex systems e.g. by carrying out these processings on pairs of systems.

Each digital image is elementally represented by a predetermined set of pixels linearly indexed 1 . . . i, j . . . in lines of pixels, with characteristics ci, cj of colour or intensity defined by octets, with one octet giving e.g. a grey level and three octets each representing a basic colour level (RGB or CMY).

For the processings below, it is expedient to determine around each indexed pixel, neighbourhoods of predetermined extent whose size expressed as number of pixels constitutes as it were the angular resolution of the depths to be recovered. This determination is made once and for all in a single site-determination stage.

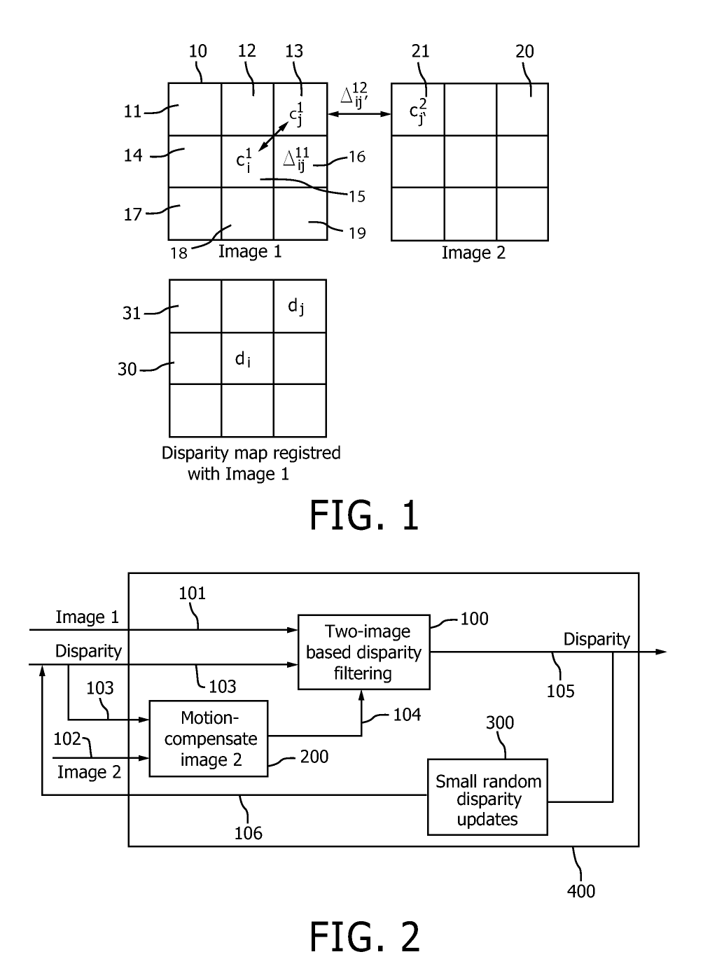

For example, each neighbourhood numbered i, j . . . may be constituted by a square with a side of 2N+1 pixels centered on the pixel i, orientated as shown in FIG. 1, with each neighbourhood or site contiguous with the four adjacent sites, which means that the pixels indexed i and i+1 of a given line of pixels are separated by a pitch P=2N+1 pixels, the lines of indexed pixels likewise being separated by the pitch or number P of non-indexed pixels.

However, one can also envisage sites that overlap, that is to say such that P is less than 2N+1; or circular sites of radius N, so that P is then less than Nx√2.

In other words, the recovery method includes an initial stage of determination of sites (i, j) of images to be pinpointed in depth that applies to maps 10, 20, 30.

The full set of these neighbourhoods or sites i, j constitute for each image 1, 2 a map 10, 20 of the sites i, j on which a number of sites 11 . . . 19, 21 . . . . have been identified, arbitrarily limited to nine in each map for the sake of simplicity of the drawing, and the algorithms between two images 10, 20 similarly provide a map 30 of sites 31 . . . showing differences between the positions of objects or characters, as will now be explained.

The processing for recovering differences or disparities or movements between the two images 1 and 2 is a recursive filtering, which will now be explained with reference to FIGS. 1 and 2.

At each iteration k of the filter, and for each site with coordinates i, j of the map 10 and a site j′ of the map 20, between each site i and j, a weighting ωi,j is calculated in accordance with formula (1) below.

ω_{i, j}=ₑ|−α|c_{i, 1}−c_{j, 1}|−β|c_{j, 1}−c_{j 1,2}|| (1)

In this formula (1), ci,1 and cj,1 are the characteristics ci and cj, alluded to above, of the sites i and j of the map 10, and cj′,2 are those of the site j′ of the map 20.
ωi,j is governed by two terms:

Δi,j:1,1=|ci,1−cj,1|

This first term (shown in FIG. 1) penalizes the difference in image characteristics between the two sites i and j of the map 10.

Δi,j′; 1,2=⊕cj, 1−cj′,2|

This second term ensures a good local average matching of the image at the sites j and j′ in the image 20, and ultimately between the two images 10 and 20, solving the problems of losses (bleeding) of depth due to relative similarities of colour and flattening of objects that have uniform colour.

The coefficients α and β are calibrated in advance and are tuned to ensure good convergence of the recursive filter.

In this case an exponential-type weighting ωi,j has been chosen, but any other type of monotonically decreasing weighting can be used. The complexity of the calculations can thereby be reduced without necessarily forfeiting rapidity of convergence.

The index j′ in the map 20 corresponds to the index j in the map 10 after computation and updating in map 30 of the disparity dj,k calculated on the basis of the results of calculation of the previous iteration k−1 in accordance with formula (2).

$${d}_{i , k} = {d}_{i , k} = {\sum }_{j} ( {ω}_{i , j} {d}_{j , k - 1} ) \qquad ( 2 )$$

More specifically, in FIG. 2, at iteration k of convergence of the filtering processing, the characteristics ci,1 of the site i of the image 1 on the one hand, and the disparity di,k−1 obtained at the output 106 of the previous iteration k−1 on the other hand, are fed to inputs 101 and 103, respectively, of a first stage 100 of calculation of disparity di,k in accordance with formula (2).

Initial values di,o of the disparities in map 30 may be random or uniform values.

At this same iteration k, the same disparity di,k−1 obtained at the output 106 of the iteration k−1 and the characteristics cj,2 of the site j of the image 2 are fed to inputs 103 and 102, respectively, of an image compensation stage 200 that uses current disparity estimate to directly shift pixels in image 2. Practically this implementation may not actually require hanging image 2 per se and can be achieved by doing a motion compensated fetch of pixels from image 2. Stage 200 gives at output 104 a new estimate of j′ of the image 2 for the site j of the image 2.

Maps 10 and 20 (or image 1 and 2) are not changed. Only map 30 is updated at each iteration.

The output 104 is fed to the input of the calculation stage 100 for calculation of the disparity di,k.

This is done in stage 100 by calculating the weighting ωi,j by formula (1), taking account of inputs 101, 103 and 104; then, once ωi,j is known, di,k is calculated by formula (2) above, and from this, the depth δi,k of the site i is deduced by formulae with which a person skilled in the art will be familiar.

In other words, the recovery method applies recursive filtering comprising two stages 100 and 200 in the course of which the disparities (di,k) between the sites i and j of the images 1 and 2, respectively, are calculated. The results of the calculation for these sites are stored in the maps 10 and 20 after the averaging of formula (2) weighted by the weights ωi,k which are simultaneously governed, through formula (2), by the characteristics ci,1, cj,1 of the pixels of the sites i and j through the coefficient α and by the image similarities between the sites j and sites j′ adjacent to the sites j, through the coefficient β.

The quality of the convergence of the filter is enhanced by the further inclusion, at each calculation iteration k, at the output 105 of the stage 100, of a stage 300 in which a small random excitation εi,k is added to the depth estimate δi,k obtained.

In fact, the random excitation is a useful step for convergence especially if uniform values are used in the initial disparity map 30.

Stages 100, 200, 300 are iterated in accordance with the above procedure for all the sites i, then these iterations on the index i are reiterated globally according to the iteration index of convergence k until a value K of satisfactory convergence of the recursive filter is attained.

It has been observed that convergence occurs after a limited number of iterations K and that this number is inversely proportional to the footprint P. The number of iterations can be limited to a threshold K that has been predetermined experimentally. One can also use a predetermined stopping criterion, for example by comparing the greatest of the differences |δi,k−δi,k−1| over the whole range of these differences extended to the sites i with a predetermined convergence threshold S. Initially, one can start from a map 30 of disparities di,o that are possible, uniform, or random, though the last of these solutions is preferred to the others. One can also start from a map of disparities that has been prepared by some other method, and thus enhance it.

The overall process is fast enough to be performed “on the fly” and in real time on all (or a sufficient number of) pairs of stereo video pictures taken by the cameras to provide in real time the corresponding successive maps 30 of the disparities di,K after convergence, or—which amounts to the same thing—the depths of the indexed pixels.

This filtering can serve equally well to detect and quantify movements of persons in a scene recorded over time by a single camera, for example by comparing the recording made up of the images ranked as odd with that made up of the ensuing images ranked as even. This enables us to exactly quantify the persons' shift and speed of movement.

So once more it can be said that the filtering processing according to the invention is executed by a recursive digital filter comprising a processor 400 which receives the data on the image 1 in a first module 100 for calculating the disparities di,k, in which a programme for calculating disparities corresponding to formula (2) is stored and executed, and the data on the image 2 in a second module 200 for calculating the disparities correction, the output 104 of the second module 200 being connected to an input of the first module for calculating disparities 100 whose output 105 is looped to the inputs 103 of both modules 100 and 200.

As a matter of fact, the output 105 of the module 100 is connected to the input of the module 300 which adds together the depth estimate at the output of the module 100 and the small random excitation to enhance the quality of the convergence of the filter. The output 106 of the module 300 is looped to the input 103 of both modules 100 and 200.

A programme for weighting calculation in accordance with formula (1) is also stored and executed in the module 100.

While the invention has been illustrated and described in detail in the drawings and foregoing description, such illustration and description are to be considered illustrative or exemplary and not restrictive, the invention being not limited to the disclosed embodiments. Other variations to said disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single processor or other unit may fulfill the functions of several items recited in the claims. The mere fact that some measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1- A method for recovery, through a digital filtering processing (100, 200, 300), of the disparities (di,k) in the digital images (1, 2; 10, 20) of a video stream containing digitized images formed of lines of pixels, so that data on the disparities (di,k) between images are yielded by the digital filtering processing, the method including an initial stage of determination of image sites (i,j) to be pinpointed in depth and the filtering being a recursive filtering (100, 200) calculating the disparities (di,k) between said sites (i,j) of said images (1, 2; 10, 20) on the basis of weighted averaging (ωi,k) governed simultaneously (1) by the characteristics (ci,1, cj,1) of the pixels of the sites (i,j) and by the image similarities between said sites (j) and sites (j′) close to said sites.

2- A method according to claim 1, wherein the quality of the convergence of the filtering is enhanced by adding (300) at each iteration (k) a small random excitation (εi,k) to the depth estimate (δi,k) deduced from the disparity (di,k).

3- A method according to claim 1, wherein the weighting (ωi,k) is of the exponential type (1).

4- A method according to claim 3, wherein the weighting is calculated in accordance with the formula
ω_{i, j}=ₑ|−α|c_{i, 1}−c_{j, 1}|−β|c_{j, 1}−c_{j 1,2}||

5- A method according to claim 1, wherein the total number of iterations of the recursive filtering (100, 200) is limited to a threshold (K) determined experimentally beforehand.

6- A method according to claim 1, wherein a convergence criterion (S) is used for stopping the filtering.

7- A method according to claim 1, wherein the initial disparities (di,o) of the filtering are random disparities.

8- A recursive digital filter for carrying out the method for recovering the disparities in the digital images of a video stream according to claim 1, comprising a processor (400) comprising a first module (100) for calculating disparities in which a programme for calculating disparities is stored and executed, and a second module (200) for calculating the disparities correction, the output (104) of the second module (200) being connected to an input of the first module (100) whose output (106) is looped to the inputs (103) of the first and second modules (100, 200).

9- A filter according to claim 7, wherein the first module (100) also contains a weighting calculation programme.

10- A filter according to claim 7 wherein the output of the first module (100) is connected to a third adder module (300) for enhancing the convergence quality of the filter.
